(19) United States
(12) Patent Application Publication
(10) Pub. No.: US 2007/0161775 A1
(43) Pub. Date: Jul. 12, 2007

(54) Novel polyimide and method for preparing the same

(76) Inventors: Xing-Zhong Fang, Daejeon Metropolitan City (KR); Byung-Hyun Lee, Daejeon Metropolitan City (KR); Kyung-Jun Kim, Daejeon Metropolitan City (KR); Hye-Won Jeong, Daejeon Metropolitan City (KR); Yun-Jeong Lee, Daejeon Metropolitan City (KR)

Correspondence Address: MCKENNA LONG & ALDRIDGE LLP;Song K. Jung, 1900 K Street, N.W., Washington, DC, 20006, US

(21) Appl. No.: 11/606,299

(22) Filed: Nov. 30, 2006

(30) Foreign Application Priority Data
Dec. 1, 2005 (KR) 10-2005-0116610

(51) Int. Cl. C08G 69/08

(52) U.S. Cl. 528/310

(57) ABSTRACT

Disclosed is polyimide of the following Formula 1, a polyamic acid which is a precursor of the polyimide, and a method for preparing thereof. 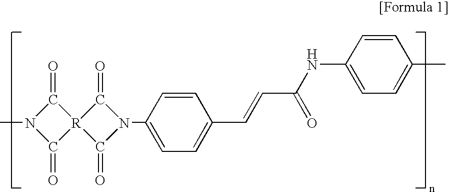 In Formula 1, R is a tetravalent organic group, and n is an integer of 1 to 1000. A liquid crystal alignment layer which contains the polyimide according to the present invention has excellent thermal stability, no residual images, and excellent alignment of liquid crystals.

### TECHNICAL FIELD

The present invention relates to a novel polyimide and a method for preparing the same.

This application claims priority from Korean Patent Application No. 10-2005-0116610 filed on Dec. 1, 2005 in the Korean Intellectual Property Office, the disclosure of which is incorporated herein by reference in its entirety.

### BACKGROUND ART

In accordance with the advance in the display industry, a low driving voltage, high resolution, reduction in volume of the monitor, and flatness of the monitor are realized in a liquid crystal display field. Accordingly, demands for liquid crystal displays are significantly growing. In liquid crystal display technologies, it is essential to align liquid crystals in a desired direction.

In the current LCD industry, a contact-type rubbing process is used as a known process of aligning liquid crystals. The process includes applying a polymer film formed of a polymer such as polyimide on a substrate such as glass, and rubbing a surface of the resulting substrate using fibers such as nylon and polyester in a predetermined direction. Alignment of the liquid crystals using the contact-type rubbing process is advantageous in that stable alignment ability of the liquid crystals is assured using a simple process. However, problems may occur during the production of liquid crystal panels due to the damage of the substrate caused by fine dust or electrostatic discharge (ESD) generated when the fibroid materials are rubbed with the polymer film, and the troubles of the process such as the increased process time and nonuniform rubbing strength resulting from the use of large rolls according to the use of enlarged glass.

Recently, many studies have been made to produce an alignment layer using a novel contactless-type process in order to avoid the above problems of the contact-type rubbing process. Examples of the contactless-type process of producing the alignment layer include an optical alignment process, an energy beam alignment process, a vapor deposition alignment process, and an etching process using lithography. However, the contactless-type alignment layer is difficult to be commercialized due to low thermal stability and residual images as compared to the alignment layer produced using the contact-type rubbing.

Particularly, in the case of the photoalignment layer, since thermal stability is significantly reduced and the residual images are maintained for a long time, the photoalignment layer cannot be commercially produced even though convenience of the process is assured.

With respect to improvement in thermal stability, Korean Patent No. 10-0357841 discloses novel linear and cyclic polymers or oligomers of coumarin and quinolinol derivatives having the photoreactive ethene group, and the use of the polymers or the oligomers as the liquid crystal alignment layer. However, the patent is problematic in that residual images are very easily formed due to a rod-shaped mesogen bonded to a main chain.

To avoid the above-mentioned problem regarding the residual images, Korean Patent No. 10-0258847 suggests a liquid crystal alignment layer that is mixed with a thermosetting resin or has a functional group capable of being thermally cured. However, the patent is problematic in that alignment and thermal stability are poor.

It is known that examples of the photoreaction using radiation of ultraviolet rays include the photoreaction of cinnamate, coumarin or the like, the photo-isomerization reaction of cis-trans isomerization, and decomposition due to breaking of the molecular chain. There are some examples of the application of the molecular photoreaction to the alignment of the liquid crystals by means of the desirable molecule design of the alignment layer material and optimization of the radiation condition of ultraviolet rays. With respect to the examples, many patents have been suggested in LCD industry field of Japan, Korea, Europe, and the U.S.A since the patent of Gibbons and Schadt had been announced in the year 1991. However, the above-mentioned technologies are not applied to LCDs even after 10 years that the initial idea was suggested. The reason for this is as follows. Even though the alignment of the liquid crystals may be performed using the photoreaction, it is impossible to maintain or provide the stable alignment of the liquid crystals against heat, light, physical impact, and chemical impact. This is mainly caused by poor anchoring energy, poor stability of the alignment of the liquid crystals, residual images or the like, as compared with the rubbing process.

Most of known studies and patents have been made to overcome the above-mentioned problems by design of photosensitive functional groups. To achieve this, there was an attempt to deform molecular structures. However, a desirable solution has not been suggested. The reason is believed that it is difficult to maintain the stable alignment of liquid crystals using only photoreaction.

Additionally, the known liquid crystal alignment layer which contains polyimide is subjected to heat treatment and then aligned in both a rubbing method and a method using ultraviolet rays so that imidization of the polyamic acid is fully achieved. However, the liquid crystal alignment layer which is produced through the above-mentioned procedure is problematic in that thermal stability is significantly reduced and the residual image is continued for a long time.

### DISCLOSURE

[Technical Problem]

The present inventors have conducted studies into a liquid crystal alignment layer having excellent thermal stability and no residual image, resulting in the finding that a polyamic acid having a novel structure is prepared, ultraviolet rays are radiated on the polyamic acid, and an imidization process is performed to produce a liquid crystal alignment layer having excellent thermal stability, no residual images, and excellent alignment of liquid crystals, thereby accomplishing the present invention.

An object of the present invention is to provide polyimide having a novel structure, and a polyamic acid that is a precursor of polyimide.

Another object of the present invention is to provide a method of producing polyimide.

### TECHNICAL SOLUTION

The present invention provides polyimide represented by the following Formula 1.

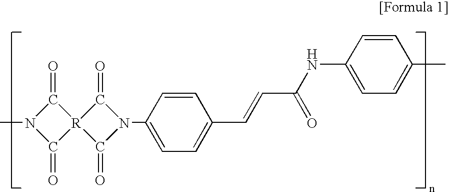

In the above Formula 1, R is a tetravalent organic group, and n is an integer of 1 to 1000.

Preferably, in the above Formula 1R is selected from the group consisting of the following structural formulae.

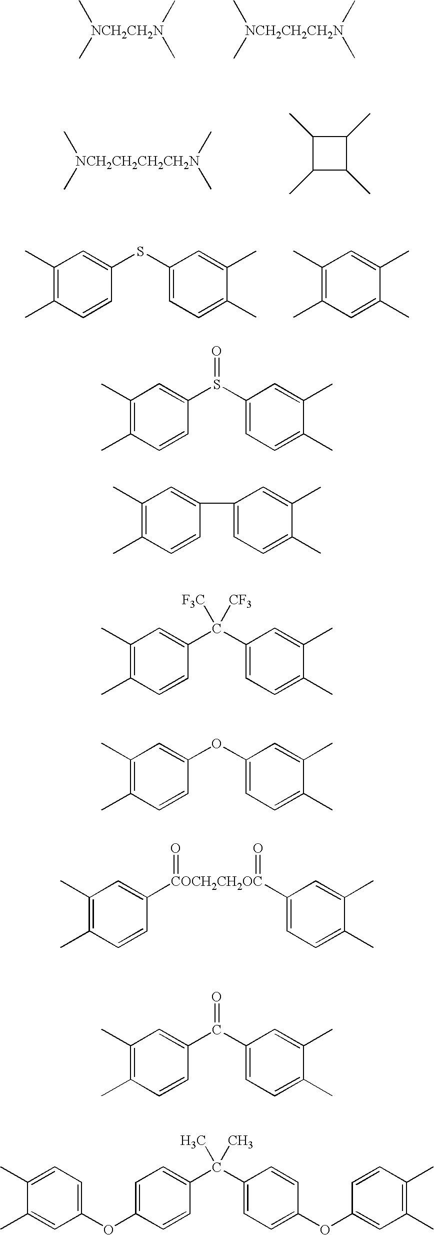

Polyimide of the above Formula 1 may be prepared by radiating ultraviolet rays on a polyamic acid represented by the following Formula 2 to perform imidization.

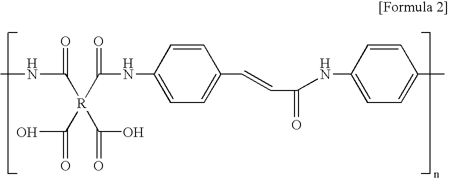

In the above Formula 2, R is a tetravalent organic group, and n is an integer of 1 to 1000.

In the above Formula 2, R is preferably selected from the group consisting of the following structural formulae.

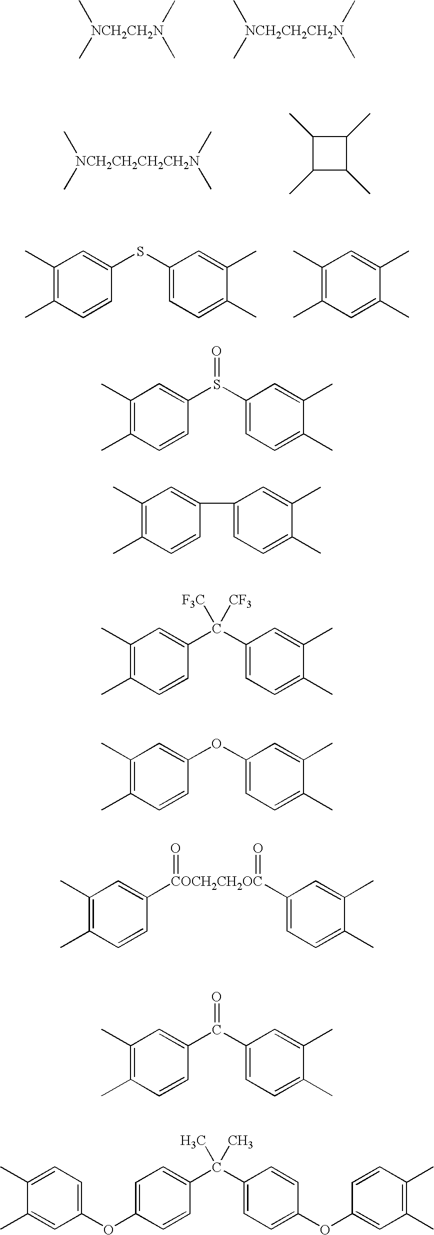

A method for preparing polyimide of Formula 1 according to the present invention comprises the steps of

1) reacting a 4-nitrocinnamic acid and thionyl chloride, and reacting 4-nitroaniline to prepare (4′-nitrophenyl)-4-nitrocinnamide,

2) reacting (4′-nitrophenyl)-4-nitrocinnamide prepared in step 1 with water/isopropanol, conc. HCl, and iron powder to prepare (4′-aminophenyl)-4-aminocinnamide, and

3) reacting (4′-aminophenyl)-4-aminocinnamide prepared in step 2 with a dianhydride compound to prepare the polyimide.

Examples of the dianhydride compound which is used in step 3 include, but are not limited to one or more selected from the group consisting of ethylene diamine tetraacetic dianhydride (EDADA), propylene diamine tetraacetic dianhydride (PDADA), butylene diamine tetraacetic dianhydride (BDADA), pyromellitic dianhydride (PMDA), 4,4′-biphthalic dianhydride (BPDA), 3,3′, 4,4′-benzophenone tetracarboxylic dianhydride (BTDA), 4,4′-oxydiphthalic anhydride (ODPA), 4,4′,4,4′-isopropyl biphenoxy biphthalic anhydride (BPADA), 4,4′-(hexafluoroisopropylidene)diphthalic dianhydride (6-FDA), 1,2,3,4-cyclobutane-tetracarboxylic dianhydride (CBDA), and ethylene glycol bis(anhydro-trimellitate) (TMEG).

### DESCRIPTION OF DRAWINGS

FIG. 1 illustrates thermal stability of a liquid crystal alignment layer produced in Preparation example 1;

FIG. 2 illustrates thermal stability of a liquid crystal alignment layer produced in Comparative preparation example 1 (in black rectangular regions, polarized ultraviolet rays are radiated to align liquid crystals, and, in grey edges, the liquid crystals are not aligned);

FIG. 3 illustrates alignment of liquid crystals of the liquid crystal alignment layer containing polyimide according to the present invention with respect to the preparation method;

FIG. 4 illustrates alignment of liquid crystals of a liquid crystal alignment layer produced in Comparative preparation example 1 and 2;

FIG. 5 illustrates thermal stability of a liquid crystal alignment layer produced in Comparative preparation example 2.

### BEST MODE

A liquid crystal alignment layer according to the present invention may be preferably produced using the following method.

The method comprises the steps of

1) dissolving a polyamic acid of Formula 2 in an organic solvent to prepare a liquid crystal alignment solution, and applying the liquid crystal alignment solution to a surface of a substrate to form a coat layer,

2) drying over the solvent that is contained in the coat layer,

3) radiating polarized ultraviolet rays on the dried coat layer to perform alignment, and

4) heat treating the aligned coat layer to perform imidization.

The method of producing the liquid crystal alignment layer according to the present invention will be described in detail.

In step 1, the polyamic acid of Formula 2 is dissolved in the organic solvent to prepare a liquid crystal alignment solution. The liquid crystal alignment solution is applied on a surface of a substrate on which a transparent conductive layer or a metal electrode is patterned using a process such as a roll coater process, a spinner process, a printing process, an inkjet spray process, and a slit nozzle process.

The concentration of liquid crystal alignment solution, the type of solvent, and the type of coating process depends on the use and the type of each polyamic acid.

Examples of the organic solvent include, but are not limited to cyclopentanone, cyclohexanone, N-methylpyrrolidone, DMF (dimethylformamide), THF (tetrahydrofuran), CCl₄, and a mixture thereof.

In the liquid crystal alignment solution, the concentration of polyimide is selected in consideration of the molecular weight, viscosity, and volatility of the polyamic acid, and preferably selected in the range of 0.5 to 20 by weight. The liquid crystal alignment solution according to the present invention is applied on the surface of the substrate that constitutes a liquid crystal display to form a layer acting as the liquid crystal alignment layer. In this case, the concentration of the solid of polyimide varies according to the molecular weight of the polyamic acid copolymer. If the concentration of the solid of polyimide is 0.5 by weight or less even though the molecular weight of the polyamic acid copolymer is sufficiently high, since the thickness of the liquid crystal alignment layer is very small, it is difficult to obtain the desirable alignment of liquid crystals. If the concentration is more than 20 by weight, since the viscosity of the liquid crystal alignment solution is excessively increased, the coating property is easily deteriorated. And it is difficult to obtain the desirable alignment of liquid crystals due to the thickness of the liquid crystal alignment layer is very large. During the production of the liquid crystal alignment solution according to the present invention, the temperature is 0 to 100° C., and preferably 15 to 70° C.

After the coating is performed, in order to assure uniformity of the thickness of the liquid crystal alignment layer and to prevent printing defects, a solvent such as ethylene glycol monoethyl ether acetate, ethylene glycol monoisopropyl ether, or ethylene glycol monomethyl ether may be used in combination with the above-mentioned organic solvent.

Furthermore, during the application of the liquid crystal alignment solution, in order to improve adhesion of the surface of the substrate, transparent conductive layer, the metal electrode, and the coat layer, a functional silane-containing compound, a functional fluorine-containing compound, or a functional titanium-containing compound may be applied in advance.

In step 2, the solvent may be dried over using the heating of the coat layer or a vacuum vaporization process at 35 to 80° C., and preferably 50 to 75° C. within 3 min.

If the substrate is heated at 80° C. or more, since the imidization reaction of the polyamic acid copolymer is performed before the photoalignment process, the alignment of liquid crystals may be reduced after the alignment process. Therefore, only the solvent that is contained in the coat layer after the liquid crystal alignment solution is applied is removed by heat treatment or vacuum vaporization according to the present invention. Thereby, the polyamic acid copolymer is present while being not polyimidized.

In step 3, ultraviolet rays having a wavelength of 150 to 450 nm may be radiated on the dried coat layer that is formed in step 2 to perform the alignment. In connection with this, the intensity of exposure depends on the type of polyamic acid, and energy of 50 mJ/cm² to 10 J/cm², and preferably 500 mJ/cm² to 5 J/cm², may be radiated.

The alignment is performed by the radiation of ultraviolet rays that are polarized by means of transmission or reflection of the ultraviolet rays with respect to \hat{1} a polarizing device using a transparent substrate, such as quartz glass, soda lime glass, and soda lime-free glass, on which dielectric isotropic material is coated, \hat{2} a polarizing plate on which aluminum or metal wires are finely deposited, or \hat{3} a Brewster polarizing device using reflection of quartz glass. In connection with this, the polarized ultraviolet rays may be perpendicularly radiated to the substrate, or inclinedly at a predetermined angle. Thereby, the desirable alignment of liquid crystal molecules is provided to the coat layer.

In step 4, the layer in which the liquid crystals are aligned by the radiation of the polarized ultraviolet rays may be heated at 80 to 300° C., and preferably 115 to 300° C., for 15 min or more to perform stabilization. The polyamic acid copolymer is subjected to ring-closing dehydration through the heat treatment process to be converted into a polyimide copolymer.

The thickness of the final coat layer that is formed through the above-mentioned procedure is 0.002 to 2 μm. It is preferable that the thickness be in the range of 0.004 to 0.6 μm in order to produce the desirable liquid crystal display device.

After the above-mentioned procedure, it is possible to produce a photoalignment layer having the liquid crystal alignment that is stable to external heat and physical and chemical impacts.

The liquid crystal alignment layer according to the present invention may be produced using a method that is known in the related art, and may include typical solvents or additives in addition to polyimide.

In the case of the liquid crystal alignment layer that is produced using the method of producing the liquid crystal alignment layer according to the present invention, ultraviolet rays are radiated on movable chains of the polyamic acid before the polyamic acid is imidized to be converted into polyimide so as to perform alignment, and heat treatment is then performed to conduct imidization. Thus, thermal stability is excellent, residual images are not formed, and alignment of liquid crystals is excellent as compared to a known method that includes radiating ultraviolet rays after the polyamic acid is imidized (FIG. 3).

Additionally, the present invention provides a liquid crystal display that includes the liquid crystal alignment layer.

The liquid crystal display may be produced using a typical method that is known in the related arts.

The liquid crystal display that includes the liquid crystal alignment layer according to the present invention has excellent thermal stability and no residual images.

### MODE FOR INVENTION

A better understanding of the present invention may be obtained in light of the following Examples and Comparative preparation examples which are set forth to illustrate, but are not to be construed to limit the present invention.

### EXAMPLE 1

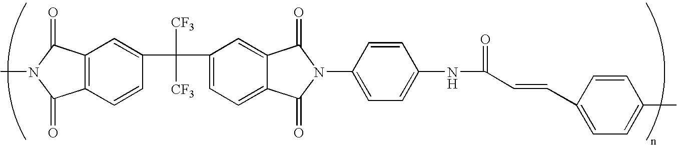

1. Preparation of (4′-nitrophenyl)-4-nitrocinnamide

19.32 g (0.1 mole) of 4-nitrocinnamic acid was put into the reaction vessel, and a small amount of DMF and 60 g of thionyl chloride were added under a nitrogen atmosphere. The mixture was stirred and heated to 70° C. until the solution was transparent. Unreacted thionyl chloride was removed at a reduced pressure to prepare 20 g of 4-nitrocinnamoyl chloride. 6.5 g (0.047 mole) of 4-nitroaniline, and 60 mL of toluene were put into the reaction vessel while they were stirred under a nitrogen atmosphere. The solution of 10 g (0.047 mole) of 4-nitrocinnamoyl chloride in 10 mL of dioxane was quickly added to the former solution under a nitrogen atmosphere. The mixture was stirred at 110° C. for 6 hours. The resulting solution was dried over at the reduced pressure to prepare 15 g of (4′-nitrophenyl)-4-nitrocinnamide.

2. Preparation of (4′-aminophenyl)-4-aminocinnamide

5.20 g (0.01 mole) of (4′-nitrophenyl)-4-nitrocinnamide that was prepared according to No. 1, 30 mL of water, and 120 mL of isopropanol were put into the reaction vessel. The mixture was heated to 70° C. while being stirred. 5 mL of conc. HCl and 30 g of iron powder were added to the reaction vessel. After 12 hours, the solution was filtered to remove unreacted iron. The filtered solution was concentrated, and then diluted with water. The resulting solution was neutralized with a sodium hydroxide aqueous solution, and then extracted with methylene chloride. The methylene chloride layer was concentrated and recrystallized to prepare 3.8 g of (4′-aminophenyl)-4-aminocinnamide.

3. Preparation of the Polyamic Acid Copolymer

3.50 g (0.0138 mole) of (4′-aminophenyl)-4-aminocinnamide that was prepared according to No. 2, and 60 mL of NMP were put into the reaction vessel that was provided with the agitator. 5.79 g (0.0138 mole) of 4,4′-(hexafluoroisopropylidene)diphthalic dianhydride (6-FDA) was added at room temperature, and stirred for 20 hours to prepare a viscous polyamic acid solution.

4. Preparation of polyimide

3 mL of triethyl amine, 5 mL of acetic anhydride, and 20 mL of NMP were added to the polyamic acid solution that was prepared according to No. 3, and stirred at room temperature for 24 hours. The resulting solution was poured into methanol, and filtered to separate. The filtered solution was dried over to prepare 8.2 g of polyimide powder.

IR: 1782,1722,1650,1633, 1372, 727 cm⁻¹.

### EXAMPLE 2

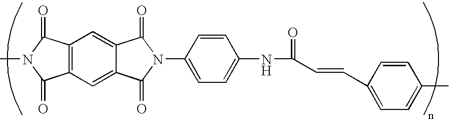

5.40 g (0.021 mole) of (4′-aminophenyl)-4-aminocinnamide that was prepared according to No. 2 of Example 1, and 80 mL of NMP were put into the reaction vessel that was provided with the agitator. 4.65 g (0.021 mole) of pyromellitic dianhydride (PMDA) was added at room temperature, and continuously stirred for 20 hours to prepare a viscous polyamic acid solution.

4 mL of triethyl amine, 8 mL of acetic anhydride, and 20 mL of NMP were added to the polyamic acid solution, and stirred at room temperature for 24 hours. The resulting solution was poured into methanol, and filtered to separate. The filtered solution was dried over to prepare 8.9 g of polyimide powder.

Ir: 1784,1725, 1651, 1630, 1373, 721 cm⁻¹.

### EXAMPLE 3

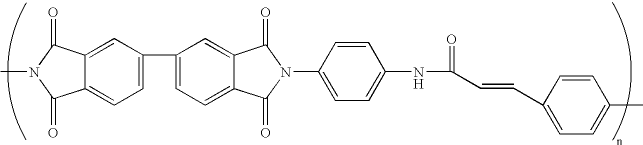

4,30 g (0.017 mole) of (4′-aminophenyl)-4-aminocinnamide that was prepared according to No. 2 of Example 1, and 77 mL of NMP were put into the reaction vessel that was provided with the agitator. 4.99 g (0.017 mole) of 4,4′-biphthalic dianhydride (BPDA) was added at room temperature, and continuously stirred for 20 hours to prepare a viscous polyamic acid solution.

3 mL of triethyl amine, 5 mL of acetic anhydride, and 20 mL of NMP were added to the polyamic acid solution, and stirred at room temperature for 24 hours. The resulting solution was poured into methanol, and filtered to separate. The filtered solution was dried to prepare 8.1 g of polyimide powder.

IR: 1783,1721, 1654,1628, 1370, 728 cm⁻¹.

### EXAMPLE 4

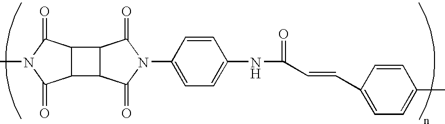

2.69 g (0.011 mole) of (4′-aminophenyl)-4-aminocinnamide that was prepared according to No. 2 of Example 1, and 40 mL of NMP were put into the reaction vessel that was provided with the agitator. 2.08 g (0.011 mole) of 1,2,3,4-cyclobutane-tetracarboxylic dianhydride (CBDA) was added at room temperature, and continuously stirred for 20 hours to prepare a viscous polyamic acid solution.

2 mL of triethyl amine, 4 mL of acetic anhydride, and 15 mL of NMP were added to the polyamic acid solution, and stirred at room temperature for 24 hours. The resulting solution was poured into methanol, and filtered to separate. The filtered solution was dried to prepare 4.08 g of polyimide powder.

IR: 1775, 1710, 1656, 1356 cm⁻¹.

### PREPARATION EXAMPLE 1

Production of the Liquid Crystal Alignment Layer

1. Production of the liquid crystal alignment solution

The polyamic acid that was prepared according to Example 1 was dissolved in the solution of N-methylpyrrolidone and butylcellosolve (2-butoxy-ethanol) mixed with each other (7:3) so that the concentration of nonvolatile components of the polyamic acid was 2%, and then filtered using the filter of 0.2 μm to prepare the liquid crystal alignment solution.

2. Production of the Liquid Crystal Alignment Layer

The liquid crystal alignment solution that was prepared according to No. 1 was applied to the glass substrate on which the indium tin oxide (ITO) electrode was formed, to the thickness of 80 nm. The glass substrate was dried at 80° C. within 3 min to remove the solvent. Ultraviolet rays were inclinedly radiated on the surface of the glass substrate on which the liquid crystal alignment solution was applied at the inclination angle of 0 to 30° at the intervals of 5 sec, 10 sec, 30 sec, 1 min, 5 min, and 10 min to cause the photoreaction. After the photoreactive adhesive that contained ball spacers was applied on an edge of any one substrate of the two glass substrates that were subjected to the photoreaction, another glass substrate was attached to the glass substrate having the adhesive, and ultraviolet rays were radiated on only a portion of the glass substrate on which the adhesive was applied to perform the attachment. Liquid crystals were injected into the produced layer, and then subjected to heat treatment at 200° C. or more for 15 min or more to complete the production of the liquid crystal alignment layer.

### COMPARATIVE PREPARATION EXAMPLE 1

1. Preparation of Polyimide

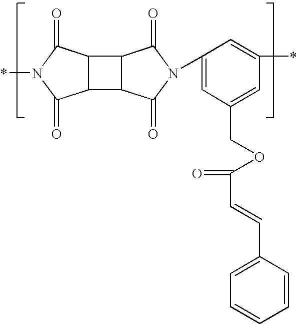

1. Preparation of (E)-3,5-dinitrobenzyl cinnamate

After 35 mL of acetone was put into a round-bottom flask of 50 mL, 9.90 g (50 mmol)3,5-dinitrobenzyl alcohol was dissolved. 3.87 mL (50 mmol) of pyridine was added to the solution and stirred. 8.33 g (50 mmol) of cinnamoyl chloride was dissolved in 35 mL of acetone, and then slowly dropped to the mixture using the dropping funnel. The temperature was increased to 60° C., and the reaction was carried out for 18 hours. After the reaction was finished, acetone was completely removed. The resultant was dissolved in methylene chloride and workup with sodium hydrogen carbonate (NaHCO₃) and a sodium chloride (NaCl) aqueous solution, and dried over with magnesium sulfate (MgSO₄) to prepare 12.36 g of (E)-3,5-didinitrobenzyl cinnamate (yield 75%).

1-2. Preparation of (E)-3,5-Diaminobenzyl Cinnamate

After (E)-3,5-dinitrobenzyl cinnamate that was prepared according to No. 1-1 was dissolved in 150 mL of acetone at 60° C., and 10 mL of H₂O was added. As a result, white crystals were produced. 60 mL of acetone was added to dissolve the crystals. After the crystals were completely dissolved, 21 g of Fe was added and stirred for about 5 min to be dispersed desirably. Unreacted iron was then removed, 1 mL of HCl was slowly added. After the reaction was carried out for about 30 min, iron and HCl were added in the same amount, and the reaction was then carried out for 18 hours. The reaction was completed, iron was filtered using the filter, the solvent was completely removed, and the resultant was dissolved in methylene chloride. After the solution was subjected to workup with sodium hydroxide and sodium chloride, water was removed with magnesium sulfate, and the solvent was removed to prepare 7 g of (E)-3,5-diaminobenzyl cinnamate (yield 60%).

1-3. Preparation of the Polyamic Acid

After 3.5 g (13 mmol) of (E)-3,5-diaminobenzyl cinnamate which was prepared according to No. 1-2 was stirred in 24.24 g (20% by weight) of N-methyl-2-pyrrolidone until being completely dissolved, 2.56 g (13 mmol) of 1,2,3,4-cyclobutane-tetracarboxylic dianhydride (CBDA) was added. And the reaction was carried out for 12 hours in an ice bath. All the reaction was carried out under a N₂ atmosphere. After the reaction was completed, the resultant was precipitated in H₂O to prepare the polyamic acid.

1-4. Preparation of Polyimide

0.435 g (PAA repeating unit: acetic anhydride=1:5) of acetic anhydride was added to 2 g of the polyamic acid solution (PAA: 0.4 g, NMP: 1.6 g) that was prepared according to No. 1-3, and 0.201 mL of pyridine (Ac₂O/pyridine=2/1 volume ratio) was added, and the reaction was carried out for 12 hours. After the reaction was completed, the resultant was precipitated in methanol to prepare polyimide.

2. Preparation of the Liquid Crystal Alignment Solution

In the same manner as in No. 1 of Preparation example 1, the liquid crystal alignment solution was prepared, except that polyimide (100 mg) prepared according to No. 1 was used instead of the polyamic acid copolymer of Example 1.

3. Production of the Liquid Crystal Alignment Layer

The liquid crystal alignment solution that was prepared according to No. 2 was applied to the glass substrate on which the indium tin oxide (ITO) electrode was formed, to the thickness of 80 nm. The glass substrate was dried at 80° C. within 3 min to remove the solvent. The dried layer was subjected to heat treatment at 200° C. or more for 15 min or more. Ultraviolet rays having the wavelength in the range of 150 to 450 nm were radiated on the surface of the layer that was subjected to the heat treatment, to perform the alignment. Two glass substrates that were subjected to the alignment were attached to each other while the surfaces of the substrates that were subjected to the alignment faced each other. In connection with this, two resulting structures in which the distance between the two attached glass substrates, that is, the gap, is 60 to 90 μm and 4 to 5 μm were produced. In the case of the cell having the gap of 60 μm or more, the double-sided tape was used to perform the attachment. In the case of the cell having the gap of 5 μm or less, after the ball spacers or the column spacers were formed on the glass substrate, the fixing was performed using the UV sealant to produce the test cells having a predetermined gap. The liquid crystals were injected into the cells by the capillary action to produce the liquid crystal alignment layer.

### COMPARATIVE PREPARATION EXAMPLE 2

In the same manner as in Comparative preparation example 1, the liquid crystal alignment layer was prepared, except that the heating treatment is performed after irradiation of ultraviolet rays for alignment.

### EXPERIMENTAL EXAMPLE 1

Evaluation of Initial Alignment(Preparation Example 1 and Comparative Preparation Example 1).

In order to evaluate the initial alignment of the liquid crystal alignment layer that was produced, the following test was performed.

The liquid crystal alignment layers that were produced according to Preparation example 1 and Comparative preparation example 1 were put on the light box having the polarizing plate attached thereto, and another polarizing plate was provided to the liquid crystal alignment layers so that the two polarizing plates were intersect to observe the liquid crystal alignment of the alignment layers. The liquid crystal alignment was evaluated based on the traces of the flowing liquid crystals and light leakage.

The results are described in the following Table 1.

TABLE 1

| | Exposure | Exposure | Exposure |
|---|---|---|---|
| alignment layer | for 10 sec | for 50 sec | for 250 sec |
| Preparation example 1 | Excellent | Excellent | Good |
| Comparative | Acceptable | Acceptable | Very poor |
| preparation example 1 | | | |

As shown in Table 1, in the case of the liquid crystal alignment layers according to the present invention, the excellent alignment was assured without defects as a result of the observation with the naked eye. Additionally, in the case of the liquid crystal alignment layer according to Comparative preparation example 1, the initial alignment was acceptable.

### EXPERIMENTAL EXAMPLE 2

Evaluation of Thermal Stability (Preparation Example 1 and Comparative Preparation Example 1)

Thermal stability of the liquid crystal alignment layer according to the present invention was evaluated using the following test.

During the production of a liquid crystal alignment layers according to Preparation example 1, spin coating was performed, the solvent was dried off, and the exposure and heat treatments were performed. Then, the single substrate was heat treated at 280° C. for 30 min to produce a liquid crystal alignment layer. The thermal stability of the single substrate was evaluated based on the alignment of the liquid crystal.

The liquid crystal alignment layer that was produced according to Comparative preparation example 1 was subjected to the heat treatment at 140° C., 160° C., and 180° C. for 1 hour. The thermal stability of the resulting liquid crystal alignment layer was evaluated based on the alignment of the liquid crystals.

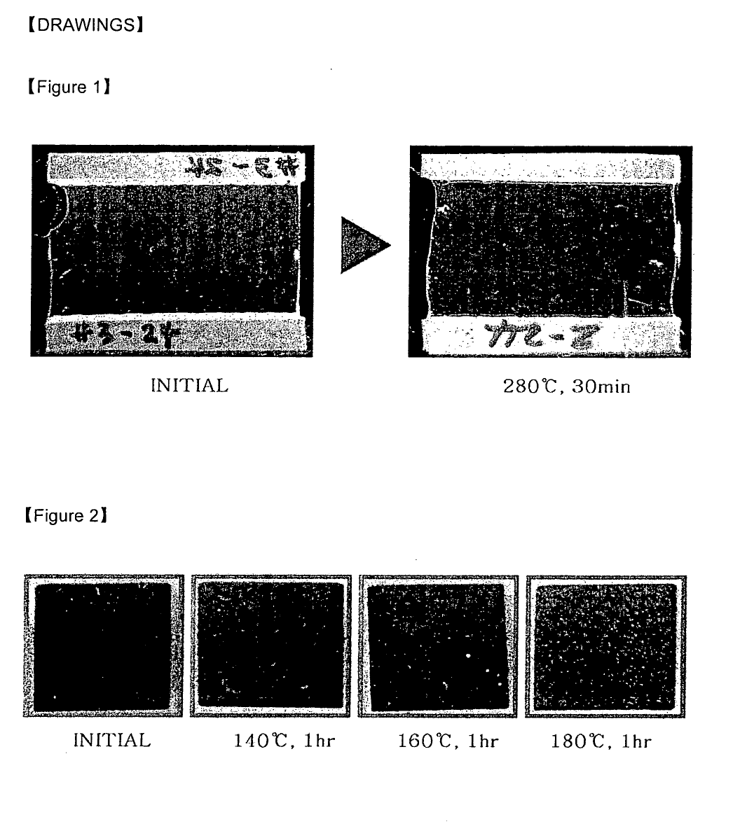

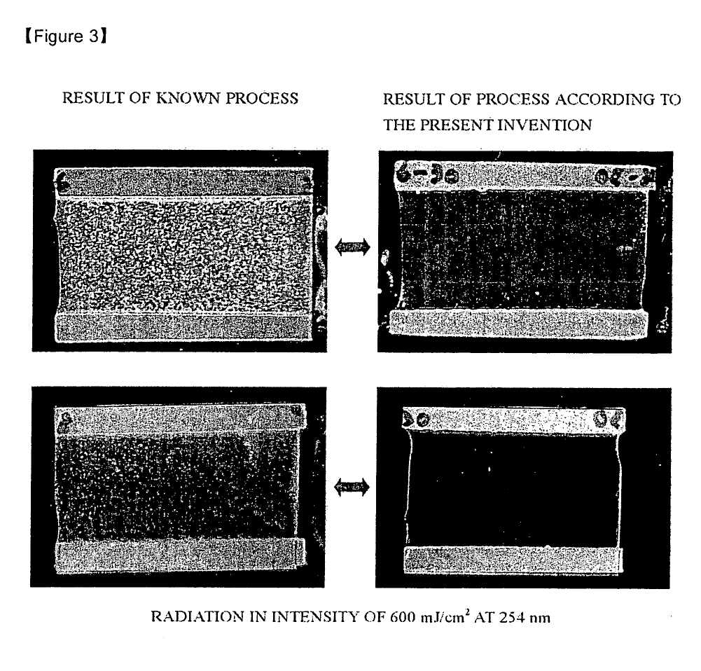

The thermal stability of the liquid crystal alignment layer according to the present invention is shown in FIG. 1. The thermal stability of the liquid crystal alignment layer produced according to Comparative preparation example 1 is shown in FIG. 2.

As shown in FIG. 1, in the case of the liquid crystal alignment layer according to the present invention, the initial alignment was maintained even after the heat treatment was performed at 280° C. for 30 min.

On the other hand, in the case of the liquid crystal alignment layer produced according to Comparative preparation example 1, as shown in FIG. 2, the initial alignment was relatively good. However, since the number of disclinations that were observed as white points was increased as the temperature of the heat treatment was increased, the alignment of the liquid crystals was reduced due to heat, and the thermal stability was not improved. This means that, even though the substance having the high thermal stability is applied to the polymer main chain of the side-chain type liquid crystal alignment layer, it is impossible to improve the thermal stability.

### EXPERIMENTAL EXAMPLE 3

Evaluation of Initial Alignment and Thermal Stability (Comparative Preparation Example 2).

In order to evaluate the initial alignment of the liquid crystal alignment layer that was produced in comparative preparation example 2, the following test was performed.

The liquid crystal alignment layers that were produced according to Comparative preparation example 1 and Comparative preparation example 2 were put on the light box having the polarizing plate attached thereto, and another polarizing plate was provided to the liquid crystal alignment layers so that the two polarizing plates were intersect to observe the liquid crystal alignment of the alignment layers. The liquid crystal alignment was evaluated based on the traces of the flowing liquid crystals and light leakage.

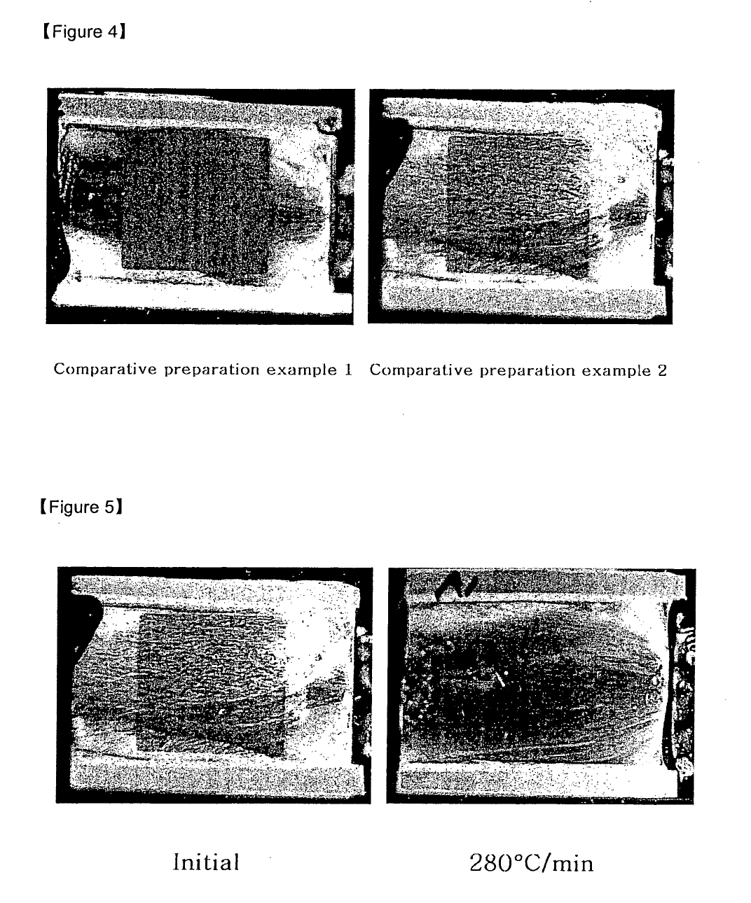

The results are described in the following FIG. 4. Comparative preparation example 1 in which alignment process is performed after heat treatment showed excellent alignment. However, comparative preparation example 2 in which heat treatment is performed after alignment process did not show good alignment because side-chain type liquid crystal alignment layer has low thermal stability.

Also, spin coating was performed, the solvent was dried off, and the exposure and heat treatments were performed. Then, the single substrate was heat treated at 280° C. for 30 min to produce a liquid crystal alignment layer. The thermal stability of the single substrate of Comparative preparation example 2 was evaluated. It was observed that the alignment effect of liquid crystal is destroyed completely (FIG. 5).

### INDUSTRIAL APPLICABILITY

A liquid crystal alignment layer that contains polyimide according to the present invention has excellent thermal stability, no residual images, and excellent alignment of liquid crystals.

1. A polyimide represented by Formula 1: 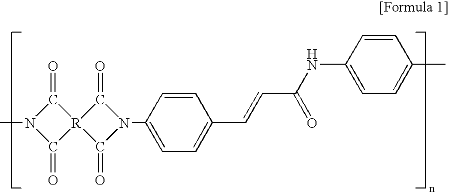
wherein R is a tetravalent organic group, and n is an integer of 1 to 1000.

2. A polyamic acid represented by formula 2: 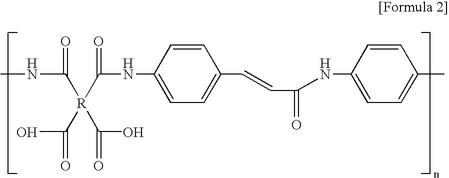
wherein R is a tetravalent organic group, and n is an integer of 1 to 1000.

3. The polyimide as set forth in claim 1,
wherein R is selected from the conisting of the following structural formulae:

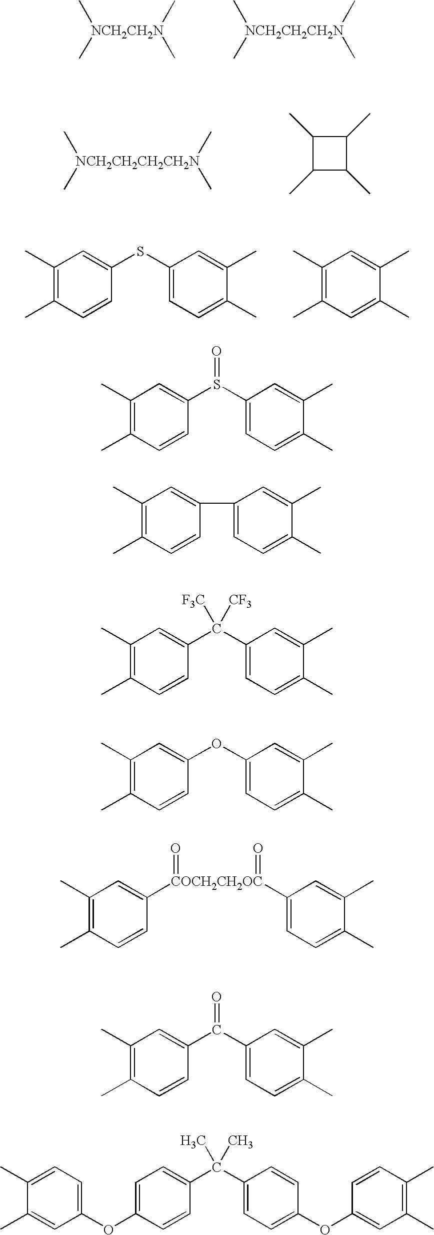

4. The polyamic acid as set forth in claim 2,
wherein R is selected from the group conisting of the following structural formulae:

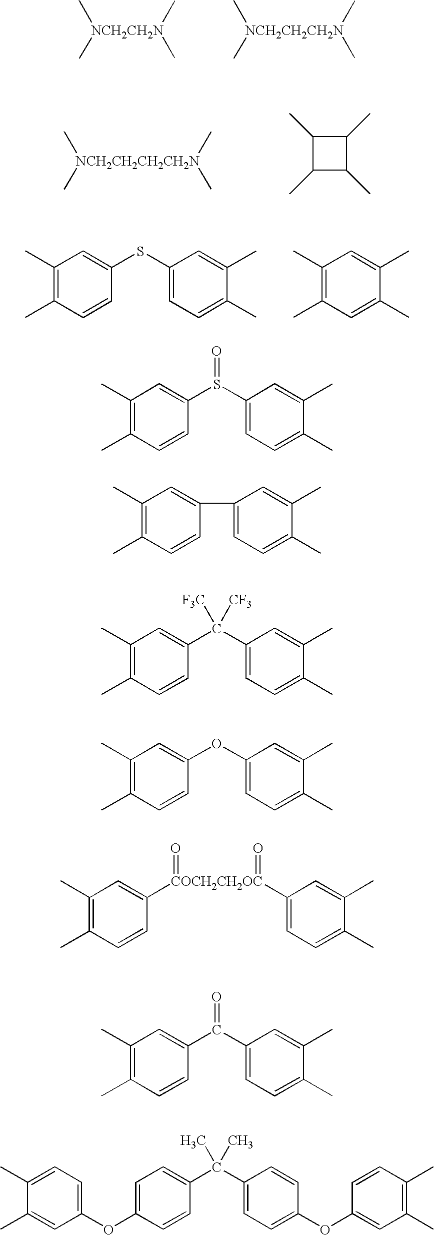

5. A method of preparing the polyimide of claim 1, comprising the steps of:
1) reacting a 4-nitrocinnamic acid and thionyl chloride, and then reacting 4-nitroaniline to prepare (4′-nitrophenyl)-4-nitrocinnamide;
2) reacting (4′-nitrophenyl)-4-nitrocinnamide prepared in step 1 with water/isopropanol, conc. HCl, and iron powder to prepare (4′-aminophenyl)-4-aminocinnamide; and
3) reacting (4′-aminophenyl)-4-aminocinnamide prepared in step 2 with a dianhydride compound to prepare the polyimide.
